(19) United States
(12) Patent Application Publication
(10) Pub. No.: US 2011/0072700 A1
(43) Pub. Date: Mar. 31, 2011

(54) Color Coded Marking System for all formats of USB Flash Drives and SD Memory Cards

(76) Inventors: Dominick Theresa, Edison, NJ (US); Michele Kramer, South Amboy, NJ (US); Nick Theresa, Edison, NJ (US)

(21) Appl. No.: 12/570,827

(22) Filed: Sep. 30, 2009

(51) Int. Cl. G09F 3/10

(52) U.S. Cl. 40/638

(57) ABSTRACT

This Color Coded Marking System that's specifically for being able to easily identity what is on each USB flash drives and all formats of SD Memory Cards and Compact Flash Memory Cards, at a quick glance. This color coded marking system consist of multi-colored, squares, rectangles or round, peel away and self-stick labels from cards or sheets which are in the form of colored write-on labels, colored pre-set word labels, colored pre-set symbol labels, colored pre-set number labels and mixed decorative design labels. This color coded marking system also contains multi-colored rings/holders and multi-colored decorative elastic wrist bands to easily carry USB Flash Drives.

### CLAIM OF PROVISIONAL

This application claim to the provisional application No. 61/100,764 filed on Sep. 29, 2008 and the provisional application No. 61/100,761 filed on Sep. 29, 2008.

### FIELD OF INVENTION

This present invention is related generally to the old B/W plain, write-on labels which were always included with any of the following: blank VHS video tapes, blank audio cassette tapes, blank 3.5 inch computer floppy diskettes, blank VHS-C, blank CD's and blank DVD's. All these blank recording devices were used to store either—music, data, pictures, movies and/or taping or recording live events. The blank write-on labels that were included within each product was provided so that a person could place information on each label and to be able to easily identify as to what was on that product, with just a quick glance.

### BACKGROUND OF INVENTION

This innovation identifies in advance, what's on each USB Flash Drive and SD Memory Cards, without having to place any USB Flash Drive or SD Card, into any reading/host device, to find out what's on each one as this problem is solved with the Color Coded Marking System which is specifically for USB Flash Drives and for all formats of SD Memory Cards which this user-friendly Color Coded Marking System is to easy distinguish and identify at a glance, what's on your USB Flash Drive and SD Memory Cards ahead of time, alleviating the headache of guessing.

### SUMMARY OF THE INVENTION

The Color Coded Marking System for USB flash drives and all formats of SD Memory Cards and Compact Flash Memory Cards is unique and the first of its kind and placing different colored rings, mix and matching together with colored elastic wrist bands, which is designed to be placed on a wrist, a much easier way to carry and transport any USB Flash Drive also using the different colored peel-off label cards as this color coded marking system is used to be able to easily identify any USB flash drive, SD Memory Card and Compact Flash Memory Card from another, in regards to the subject matter.

The terminology of the letters and words with USB Flash Drive, Compact Flash Memory Cards and all formats of SD Memory Cards with the words USB flash drive, USB drive or USB are all terms meaning Universal Serial bus and are self-contained, compact computer drives and is a flash memory data storage device. USB flash drives are typically removable, re-writable and storage capacities are with range of size.

The USB flash drives are further titled and the variants can also be found as USB flash drives 1.0, USB flash drives 2.0, USB flash drives 3.0, USB 1.0, USB 2.0, USB 3.0 and the numbers will continously go higher and higher in the future. USB flash drives and the USB connector is protected by a removable cap, a side swivel feature or retracting into the body of the drive.

USB flash drives use a standard type-A USB connection allowing plugging into a port, but drives for other inferfaces also exist. USB flash drives use a USB connection and a companion card read/writer that eliminated the need for a USB hub. USB ports, on the other hand, appear on almost every current mainstream PC, laptop, usb adapter and many other consumer electronic products/devices.

USB Flash Drives come in many difference sizes, shapes, forms, capacity and flash memory chip styles and are made by many different companies/business and/or any person that makes or sells a USB Flash Drive.

SD Memory Card, SD Card, SD, Memory Card, Flash Card or Secure Digital are all terms meaning Secure Digital Memory Card or Secure Digital Card. SD technology can be found in dozens of product categories used by more than 400 brands and offering 8,000 product models.

SD memory card standards are currently built into a wide range of digital products/devices used to either store or use data storage in digital cameras, digital video camera, multimedia cell phones, digital audio players, automotive multimedia and navigation systems, electronic books, MP3 players, personal digital assistants, handheld PCs, digital audio players, mobile phones, record video players, video game systems, electronic sd adapters and many other consumer electronic products/devices.

The family index names of some titles as to SD Memory Cards, which can also be as SD cards, SD flash memory cards, memory cards, flash memory cards, memory stick, memory stick pro duo, picture card, mobile card, gaming memory card, wi-fi memory card, bluetooth devices, smartmedia memory card, duo sd, sd plus, super digital cards and the compact flash memory card. Note that the Compact Flash Memory Card is not usually titled with the letters SD (Secure Digital) and it can stand alone by its name, Compact Flash Memory Card.

The sd cards are further titled and the variants can be found as to the type of storage, size, version, model, capacity, mode, format, read and write speed, speed class rating, traditional x speed rating and any versions of the sd specification which sd cards can be classified and used under one or more names with memory cards as:

miniSD—(Mini Secure Digital) Memory card

miniSDHC—(Mini Secure Digital High Capacity) Memory card

microSD—(Micro Secure Digital) Memory card

microSDHC—(Micro Secure Digital High Capacity) Memory card

SDHC—(Secure Digital High Capacity)

SDXC—(Secure Digital eXtended Capacity)

SDIO—(Secure Digital Input/Output)

memory stick

XM—(memory card)

XD—(memory card)

XD—(Picture card)

SDMMC—(Multi Media Card) memory card

Wi-Fi—(memory card)

GameSD—(Gaming memory card)

CF—(Compact flash memory card) CompactFlash

USB flash drives and SD memory cards are available in various formats and capacities and are used by many consumer devices. However, while virtually all PCs have USB ports, allowing the use of USB flash drives, memory card readers are not commonly supplied with pc's. Although, card readers are available that read USB flash drives and SD memory cards.

### BRIEF DESCRIPTION OF THE DRAWINGS

FIG. 1 is a illustration of 4 different color coded marking system label cards for USB flash drives and all formats of SD Memory Cards and Compact Flash Memory Cards.

FIG. 2 top is an illustration of 1 multiple mixed color coded label card (what's in FIG. 1) in additional with decorative and character designs and the bottom illustration shows at least 6 different colored metal rings/holder and 6 different colored elastic bands for USB flash drives.

FIG. 3 is a similar straight on illustration view on how 4 different sizes and shapes of USB flash drives will work and look with the Color Coded Marking System attached.

FIG. 4 is a straight on illustration view on how different sizes and shapes of all formats of SD Memory Cards and Compact Flash Memory Card will work and look with the Color Coded Marking System attached.

### DETAILED DESCRIPTION OF THE INVENTION

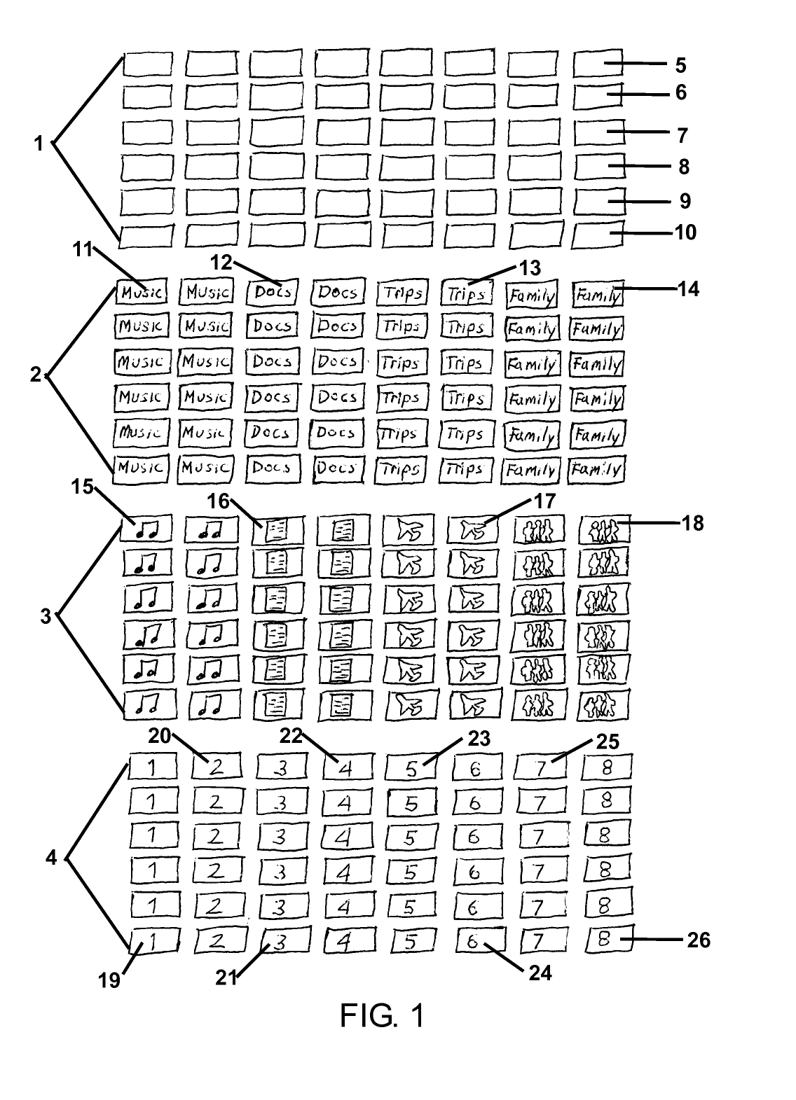

In FIG. 1 it shows four different 1, 2, 3, and 4 color coded marking system label cards for USB flash drives and all formats of SD Memory Cards and Compact Flash Memory Cards as labels shown 1, 2, 3, and 4 are squares, forms of rectangles and round labels are included with a family of color bands for either background colors or foreground colors.

In FIG. 1 the mixed colored individually peel off write-on card 1 with the write-on labels consisting with more than one of the write-on and colors with red write-on labels 5, yellow write-on labels 6, blue write-on labels 7, green write-on labels 8, purple write-on labels 9 and white write-on labels 10.

In FIG. 1 the mixed colored individually peel off pre-set words card 2 with the pre-set word labels consisting with more than one of the words and family of color bands with music labels 11, docs labels 12, trips labels 13 and family labels.

In FIG. 1 the mixed colored individually peel off pre-set symbols card 3 with the pre-set symbol labels consisting with more than one of the symbols and family of color bands with music note labels 15, paper labels 16, plane labels 17 and people labels 18.

In FIG. 1 the mixed colored individually peel off pre-set numbers card 4 with the pre-set number labels consisting with more than one of the numbers and family of color bands with the label number-1 19, number-2 20, number-3 21, number-4 22, number-5 23, number-6 24, number-7 25 and number-8 26.

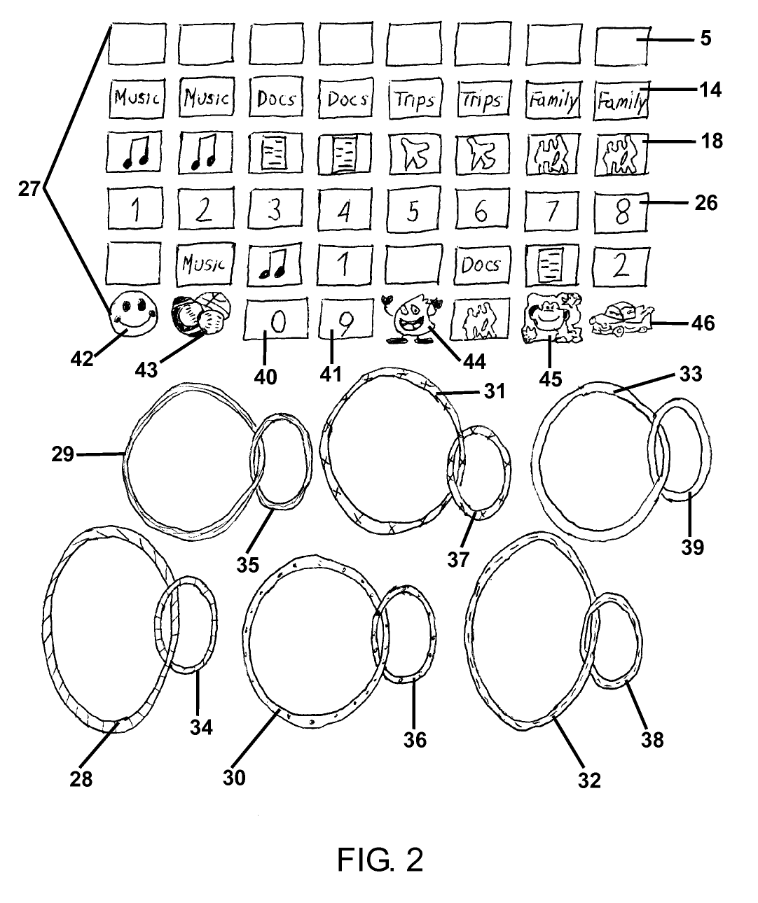

In FIG. 2 top drawing shows a multi-mixed label card 27 shown in the forms of squares, rectangles and round labels as the multi-mixed colored individually peel off card consisting with the family of color bands and with more than one of the write-on labels 5, pre-set words labels 14, pre-set symbols labels 18, pre-set number labels 26 and multi-mixed decorative design labels as a smiley face 42 as a motivational label, a monkey as an animal label 45, a sport picture for a sports label 43, a car for a cars label 46, a monster as a character label 44.

In FIG. 2 bottom drawing shows colored metal round rings and holder which may consist of one or more family of color bands, designed for any sizes, shapes or capacity usb flash drives and may consist with more than one of red ring 34, yellow ring 35, blue ring 36, green ring 37, purple ring 38 and white ring 39.

In FIG. 2 bottom drawing also shows colored elastic wrist bands which may consist of one or more family of color bands, designed for any sizes, shapes or capacity usb flash drives and may consist with more than one of red elastic wrist band 28, yellow elastic wrist band 29, blue elastic wrist band 30, green elastic wrist band 31, purple elastic wrist band 32 and white elastic wrist bands 33.

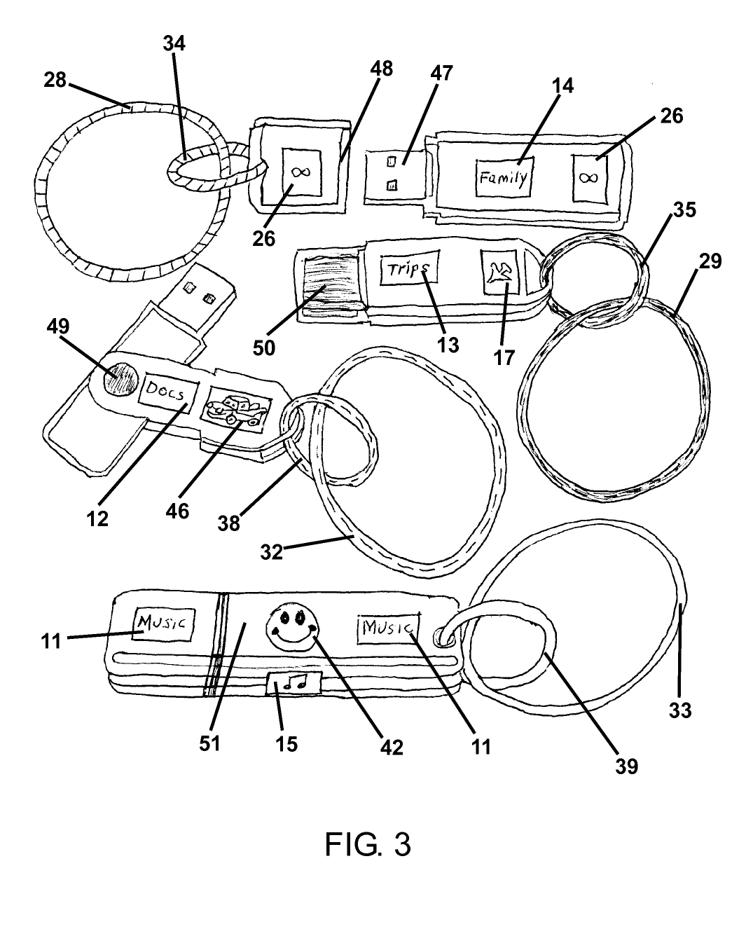

In FIG. 3 shows USB flash drives 47 and 50 with cap on, some USB connectors are protected by a removable cap 48 as some USB flash drives are swivel 49 and other USB flash drives retracting 51 into the body of the drive as all USB flash drives are shown with the color coded marking system labels, rings and elastic wrist band as well as using the multi-mixed decorative design labels as a smiley face 42 as a motivational label and a car for a cars label 46.

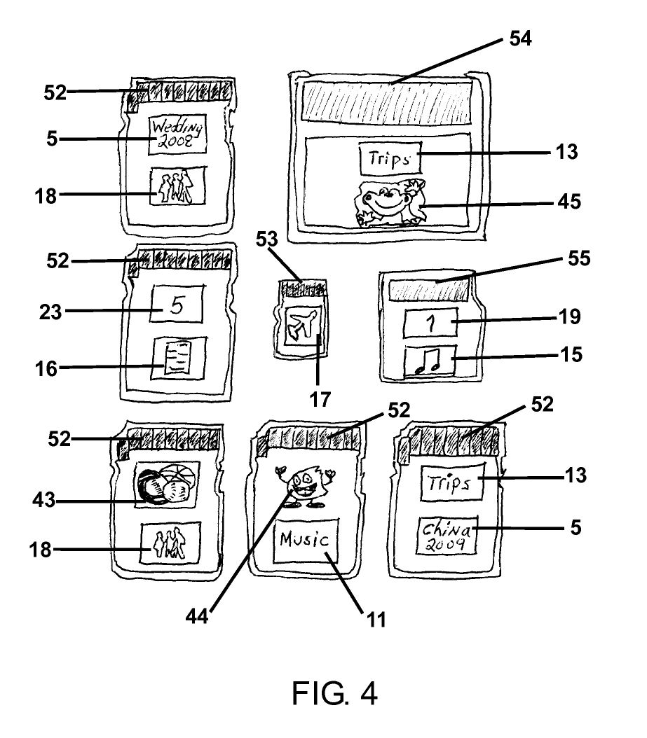

In FIG. 4 shows SD Memory Cards 52, Compact Flash Memory Cards 54, miniSD card 55 and a microSD card 53 as all formats of SD Memory Cards and Compact Flash Memory Card are shown with the color coded marking system labels as well as using the multi-mixed decorative design labels 43, 44 and 45.

What is claimed is:

1. A color coded marking system for all formats of usb flash drives and sd memory cards comprising:
a) removable square or round peel away labels on cards or sheets which contain of one or more family of color bands and one or more items selected from the list of colored write-on, colored pre-set words, colored pre-set symbols, colored pre-set numbers and colored multi-mixed decorative design labels, in which this color coded marking system was specifically designed for any sizes, shapes or capacity of usb flash drives, sd memory cards and compact flash memory cards;
b) peel away labels consisting of a light adhesive which is enough to secure applying and ensure durability but does not leave a sticky residue and does not interfere in the removal of a label for any and all label inter-changes on any usb flash drives, sd memory cards and compact flash memory cards;
c) colored metal round rings which may consist of one or more family of color bands, designed for any sizes, shapes or capacity usb flash drives;
d) colored elastic wrist bands which may consist of one or more family of color bands, designed for any sizes, shapes or capacity usb flash drives; and
e) this color coded marking system is to easily identify with just a quick glance as to what's on each usb flash drive without having to insert the said usb flash drive into any electronic or reading device.

2. The color coded marking system for usb and sd as recited in claim 1, wherein said peel away labels for a usb flash drive are in six different colors such as red, yellow, blue, green, purple and white but may be colors of either more or less than the six family of color bands stated and these said colors are in the forms of one or more squares, rectangles or round labels and each peel away label is placed on either cards or sheet that consist of one or more peel away label and each label consists of a light adhesive which is enough to secure applying and ensure durability to any and all usb flash drives.

3. The color coded marking system for usb and sd as recited in claim 2, wherein said write-on labels for a usb flash drive consist of one or more colored peel away label which is on either a card or sheet and can be individually peeled off and each write-on label may be used to include any letter, word, number, symbol, picture, decorative design or any other kind of personalization that is written or typed, in which the consumer chooses to use to mark and identify their usb flash drive.

4. The color coded marking system for usb and sd as recited in claim 2, wherein said colored pre-set word labels for a usb flash drive consist of one or more colored peel away label which is on either a card or sheet and can be individually peeled off and each of the pre-set word labels may consist of the following words that are such named as music, docs, trips or family but may include either more or less than the said four names.

5. The color coded marking system for usb and sd as recited in claim 2, wherein said colored pre-set symbol labels for a usb flash drive consist of one or more colored peel away label which is on either a card or sheet and can be individually peeled off and each of the pre-set symbol labels may consist of the following symbols that are such called a music note, a paper, a plane or people but may also include either more or less than the said four names.

6. The color coded marking system for usb and sd as recited in claim 2, wherein said colored pre-set number labels for a usb flash drive consist of one or more colored peel away label which is on either a card or sheet and can be individually peeled off and each of the pre-set numbers may consist of the following numbers 1, 2, 3, 4, 5, 6, 7, 8 but may also include either more or less than the said eight numbers.

7. The color coded marking system for usb and sd as recited in claim 1, wherein said colored metal round rings for a usb flash drive come in a family of color bands and each colored ring may attach to a pre-set hole, circle shape ring or lanyard string on each usb flash drive and whereby the colored ring allows for easy access in finding and carrying each usb flash drive and can also be used to color coordinate with the said color coded marking system labels that are placed on the usb flash drive.

8. The color coded marking system for usb and sd as recited in claim 1, wherein said colored elastic bands for a usb flash drive come in a family of color bands and each elastic band attaches to the colored metal round ring which acts as a holder for the colored elastic band and this elastic band may attach directly to the usb flash drive and whereby this said colored elastic band may also have a colored decorative elastic design of material and fabric around each colored elastic band for carrying each usb flash drive on your wrist as the elastic band is easy access when needed and whereby the elastic band can also be used to color coordinate with the said color coded marking system labels that are placed on the usb flash drive.

9. A color coded marking system for all formats of usb flash drives and sd memory cards comprising:
a) removable square or round peel away labels on cards or sheets which contain of one or more family of color bands and one or more items selected from the list of colored write-on, colored pre-set words, colored pre-set symbols, colored pre-set numbers and colored multi-mixed decorative design labels, in which this color coded marking system was specifically designed for any sizes, shapes or capacity of usb flash drives, sd memory cards and compact flash memory cards;
b) peel away labels consisting of a light adhesive which is enough to secure applying and ensure durability but does not leave a sticky residue and does not interfere in the removal of a label for any and all label inter-changes on any usb flash drives, sd memory cards and compact flash memory cards; and
c) this color coded marking system is to easily identify with just a quick glance as to what's on each sd memory card, compact flash memory card and all formats of sd memory cards without having to insert the said sd memory cards or compact flash cards into any electronic or reading device.

10. The color coded marking system for usb and sd as recited in claim 9, wherein said peel away labels for sd memory cards and compact flash memory cards are in six different colors such as red, yellow, blue, green, purple and white but may be colors of either more or less than the six family of color bands stated and in which these said colors are in the forms of one or more squares, rectangles or round labels whereby each peel away label is placed on either cards or sheet that consist of one or more peel away label and each label consists of a light adhesive which is enough to secure applying and ensure durability to any sd memory cards, compact flash memory cards and all formats of sd memory cards.

11. The color coded marking system for usb and sd as recited in claim 10, wherein said write-on labels for sd memory cards and compact flash memory cards consist of one or more colored peel away label which is on either a card or sheet and can be individually peeled off and whereby each write-on label may be used to include any letter, word, number, symbol, picture, decorative design or any other kind of personalization that is written or typed, in which the consumer chooses to use to mark and identify their sd memory cards and compact flash memory cards.

12. The color coded marking system for usb and sd as recited in claim 10, wherein said colored pre-set word labels for sd memory cards and compact flash memory cards consist of one or more colored peel away label which is on either a card or sheet and can be individually peeled off and whereby each of the pre-set word labels may consist of the following words that are such named as music, docs, trips or family but may include either more or less than the said four names.

13. The color coded marking system for usb and sd as recited in claim 10, wherein said colored pre-set symbol labels for sd memory cards and compact flash memory cards consist of one or more colored peel away label which is on either a card or sheet and can be individually peeled off and whereby each of the pre-set symbol labels may consist of the following symbols that are such called a music note, a paper, a plane or people but may also include either more or less than the said four names.

14. The color coded marking system for usb and sd as recited in claim 10, wherein said colored pre-set number labels for sd memory cards and compact flash memory cards consist of one or more colored peel away label which is on either a card or sheet and can be individually peeled off and whereby as each of the pre-set numbers may consist of the following numbers 1, 2, 3, 4, 5, 6, 7, 8 but may also include either more or less than the said eight numbers.

15. A color coded marking system for all formats of usb flash drives and sd memory cards comprising:
a) removable square or round peel away labels on cards or sheets which contain of one or more family of color bands and one or more items selected from the list of colored write-on, colored pre-set words, colored pre-set symbols, colored pre-set numbers of 0 to 9 and colored multi-mixed decorative design labels, in which this color coded marking system was specifically designed for any sizes, shapes or capacity of usb flash drives, all formats of sd memory cards and compact flash memory cards;
b) peel away labels consisting of a light adhesive which is enough to secure applying and ensure durability but does not leave a sticky residue and does not interfere in the removal of a label for any and all label inter-changes on any usb flash drives, sd memory cards and compact flash memory cards;
c) this color coded marking system is to easily identify with just a quick glance as to what's on each sd memory card, compact flash memory card and all formats of sd memory cards without having to insert the said sd memory cards or compact flash cards into any electronic or reading device; and
d) this color coded marking system has a multi-mixed decorative design label card and sheet.

16. The color coded marking system for usb and sd as recited in claim 15, wherein said peel away labels for sd memory cards and compact flash memory cards are in six different colors such as red, yellow, blue, green, purple and white but may be colors of either more or less than the six family of color bands stated and whereby these said colors are in the forms of one or more squares, rectangles or round labels in which each peel away label is placed on either cards or sheet that consist of one or more peel away labels wherein each label consist of a light adhesive which is enough to secure applying and ensure durability to any usb flash drives, all formats sd memory cards and compact flash memory cards.

17. The color coded marking system for usb and sd as recited in claim 16, wherein said colored write-on labels, colored pre-set word labels, colored pre-set symbol labels, colored pre-set number labels are placed on a multi-mixed card or sheet with any type of decorative design, picture or symbol such as a smiley face as a motivational label, a monkey as an animal label, any sport picture for a sports label, any car for a cars label, a monster as a character label or a dress as a fashion label and any other type of picture or decorative design used for marking the label and this mixed card or sheet and whereby this multi-mixed label card let a consumer chooses how to personalize as they individually peel off and placed each label on any usb flash drive, all formats of sd memory cards and compact flash memory cards to easily identify with just a quick glance as to what's on each.
